(19) United States
(12) Patent Application Publication
(10) Pub. No.: US 2002/0052849 A1
(43) Pub. Date: May 2, 2002

(54) System and methods for the production, distribution and flexible usage of electronic content in heterogeneous distributed environments

(76) Inventors: Alan J. McCutchen, Merritt Island, FL (US); Sebastian de la Chica, Longwood, FL (US)

Correspondence Address: GREENBERG-TRAURIG, 1750 TYSONS BOULEVARD, 12TH FLOOR, MCLEAN, VA, 22102, US

(21) Appl. No.: 09/939,724

(22) Filed: Aug. 28, 2001

Related U.S. Application Data
(60) Provisional application No. 60/227,907, filed on Aug. 28, 2000.
(60) Provisional application No. 60/276,950, filed on Mar. 20, 2001.

(51) Int. Cl. H04K 1/00; H04L 9/00; G06F 17/60

(52) U.S. Cl. 705/59

(57) ABSTRACT

A system to support creation, distribution and flexible usage of electronic content in distributed environments where users may have access to multiple rendering systems. The invention comprises a packaging system, a distributed network of content management servers and personal content managers. The packaging system enables a content creator to create and associate sphere of fair use and content modulation rules definitions with content. The sphere of fair use allows a content creator to define content usage boundaries that account for the availability of multiple rendering systems. The content modulation rules provide a content creator with creative control over potential content transformations for transfer to alternative rendering systems. The personal content manager allows the user to process electronic content purchases from different sources and to transform and transfer the content to additional approved rendering systems while enforcing the creative boundaries specified by a content creator.

This application claims priority from Provisional U.S. patent applicaticn Ser. No. 60/227,907, filed Aug. 28, 2000 by de la Chica, et al. which is hereby incorporated by reference in its entirety, and to Provisional U.S. patent application Ser. No. 60/276,950, filed Mar. 20, 2001 by de la Chica, et al, which is hereby incorporated by reference in its entirety. This application is also related to U.S. patent application entitled “System and Methods for the Flexible Usage of Electronic Content in Heterogeneous Distributed Environments” filed by de la Chica, et al., concurrent with the filing of this application, the teachings of which is hereby incorporated in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of production, distribution and flexible usage of electronic content or electronic data in heterogeneous distributed environments.

### BACKGROUND OF THE INVENTION

With the advent of advanced computer networking infrastructures such as the Internet and its successors, and the ever-increasing penetration of computers and computerized devices in everyday life, traditional manifestations of content—audio, visual, textual, and/or multimedia to name a few—continue to give way to higher quality electronic manifestations of said content. Electronic manifestations of content feature a series of innate properties that make them especially suitable for cheaper production, easier acquisition (including ownership transfers), and enhanced usage.

In addition to leveraging production pricing differentials brought about by faster, cheaper technology in the fields of central processing unit (CPU) speeds, data storage, and display devices, electronic manifestations of content facilitate searching and manipulation using well-known techniques in the areas of information indexing and electronic signal and symbol manipulation. Lower production costs for electronic manifestations of content have resulted in an increase in the volume of all forms of content available to end-users. In turn, increasing volumes of content have resulted in end-users being faced with a deluge of content that makes flexibility and ease of use key factors for the widespread adoption of electronic forms of content. This electronic content availability explosion has been accompanied by increasing concerns for the protection of the rights of the content creator or copyright owner (collectively “content creator”). The business and legal needs of protecting the rights of the copyright owner to these electronic manifestations of content is at odds with the mass distribution capabilities facilitated by advances in networking technology and applications.

Research and analysis of existing technology and inventions in the area of electronic content creation, acquisition, manipulation and usage show an increased focus in the following three areas: usage rights expression and enforcement, cryptographic techniques, and dedicated display devices. While the existing state-of-the-art in the aforementioned domains addresses important aspects of those domains, a vacuum exists in the areas that take advantage of the electronic medium to facilitate widespread adoption of electronic manifestations of content requiring secure delivery and controlled fair usage. In addition, existing technology and invention efforts fail to take into account the socio-economic factors accompanying the introduction of any new technology. As a result, the existing electronic content technologies and inventions tend to “get in the way” of content users accomplishing their goals, including attaining competitive advantages, informational enrichment, and entertainment.

In an information-driven environment, content users find it hard to tolerate the limitations brought about by inventions and products that hinder the content user's ability to locate, acquire, and use content in ways that protect the rights of the content owner while providing the content user with the flexibility previously afforded by earlier content technologies such as print books and magazines; music records, tapes and CDs, and movie DVDs. Current trends often force the end-user to tie the electronic content to a specific device, a tenet contrary to the uber-connectivity facilitated by advances in the communications and networking areas such as the Internet, wireless networks, and virtual private networks (VPNs).

Some inventions and commercial products exist in the usage rights technology arena that provide coverage in the areas of electronic content usage rights expression and enforcement of said rights descriptions. For example, U.S. Pat. No. 5,715,403, to Stefik, which is incorporated herein by reference, defines a limited grammar that allows the rights owner to describe a limited set of usage rights, and protocols that allows an entity to request and exercise any approved usage right defined at production tine by the rights owner. The proposed limited usage rights grammar focuses on computer-centric atomic operations such as electronic content viewing, copying, and embedding while making no provision for the premise that the content rights owner and end-user may be interested in defining more flexible usage models that go beyond binary responses to requests for simple actions on the electronic content for a particular device. U.S. Pat. No. 5,845,281, to Benson et al., which is incorporated herein by reference, addresses the issues associated with enforcing usage rights via a computer program that checks content usage control data against content usage requests by an end user, and either grants or denies such access requests. U.S. Pat. No. 6,182,218, to Saito, which is incorporated herein by reference, presents both invisible and visible digital watermarking techniques for tracking electronic content usage through the use of a digital content management program embedded in the user's system.

While the aforementioned copyright protection techniques may prove useful in simple circumstances, these inventions do not address issues brought about by the fact that most end-users own a variety of rendering devices and systems. Moreover, such inventions fail to recognize the need to provide content usage boundaries that adequately reflect and account for the environment surrounding content users where flexibility and ease of use are prime objectives. In other words, the state of the art fails to strike a balance between the content creator's copyright and piracy protection desires and the content user's yearning for flexibility and ease of electronic content use across multiple rendering devices and systems.

The field of cryptography finds its roots in ancient practices aimed to disguise, protect and securely transfer personal, political and military messages. Kahn provides in depth non-technical coverage of the history of cryptography from Ancient Times until the date of writing (1963) in his book The Codebreakers. Additional in-depth technical descriptions can be obtained from reading the Handbook of Applied Cryptography by Menezes, et al. Both books are included herein by reference. In recent years, advances in the field of public-key cryptography have given rise to the publication of standard system definitions, such as the Public Key Infrastructure (PKI), which aim to formally describe usage of advanced cryptographic techniques initially described by Diffie and Hellman in their article “New directions in cryptography” in IEEE Transaction, on Information Theory 22 (1976). U.S. Pat. No. 6,098,056, to Rusnar and Zeintara, which is incorporated herein by reference, describes a three-level PKI-based approach solution for the cryptographic problem of trusted delivery of electronic content and its decryption. U.S. Pat. No. 6,226,618, to Downs, et al., which is incorporated herein by reference, provides a variation of the three-level PKI-based electronic content decryption key transfer where the intermediary is a “trusted” clearinghouse. U.S. Pat. No. 6,237,786, to Van Wie and Weber, which is incorporated herein by reference, describes techniques that allow the invisible and indelible transfer of electronic rights management control information within a signal being transferred via an insecure channel.

As illustrated by the aforementioned cryptography-related patents and references, current state of the art focuses on improved methods for content encryption and decryption key transfer while largely ignoring many of the issues associated with the practical usage of the electronic content once securely delivered to the end user.

New advances in electronics and electronic components have provided an environment where new inventions and products are conceived either as dedicated or multi-purpose electronic content rendering devices, including music devices and electronic book devices. U.S. Pat. No. 5,636,276, to Brugger (“the '276 patent”), proposes a device for the secure, encrypted distribution of music in electronic form. U.S. Pat. No. 5,956,034, to Sachs and Pomeroy (“the '034 patent”), describes a device capable of providing secure rendering of electronic books using encryption and in-memory decryption techniques. Both the '276 and '034 patents are incorporated herein by reference. In both cases, the inventions focus mainly on generic protection of the electronic content while in transit as well as during aural or graphical rendering. Also importantly, the aforementioned patents serve to also exemplify the increasing number of content and rendering options available to users.

As seen from the provided references, the current state of the art fails to address issues associated with providing users with an experience that is both pleasant and consistent with legally and socially acceptable fair content uses. It is particularly significant to note that none of the aforementioned inventions and products makes any provisions for supporting the availability of multiple content rendering systems to the user. For the purposes of describing the invention, the term “rendering system” refers to any combination of hardware and software components used to play back the electronic content visually, aurally, or by any other sensorial means. The separation of content from content rendering systems is important since it more closely describes commonly accepted practices such as playing a music Compact Disc (CD) using a CD player inside a vehicle and later playing the same music CD in a player located inside a house. Similarly, the prior art lacks provisions and mechanisms to define fair use in terms of such common and lawful content usage practices.

### SUMMARY OF THE INVENTION

Accordingly, the present invention is directed to systems and methods for production, distribution and flexible usage of electronic content in heterogeneous distributed environments that substantially obviates one or more of the problems due to limitations and disadvantages of the related art.

An object of the present invention is to provide a system and methods to create electronic manifestations of content consisting of actual content data, and a description of the sphere of fair content use and content modulation rules.

A further object of the present invention is to provide a system and methods that allow a content creator and/or content copyright owner to define a sphere of fair use and content modulation rules for electronic content. These definitions allow a content creator to define what is considered fair use and valid modulation for the electronic manifestation of the product of his or her creativity. In addition, these definitions become increasingly important given the ease with which electronic content can be transferred, transformed, copied, and distributed across rendering systems and the large variety of content rendering choices available to users.

An additional object of the present invention is to provide a system and methods that allow electronic content distributors to access and present to prospective content acquirers all or part of the information describing the content creator's defined sphere of fair use and content modulation rules.

Another object of the present invention is to provide a system and methods that allow users to create, manipulate, store, and retrieve their own spheres of fair use and content modulation rules via programmatic, textual, or graphical manipulation of symbols.

Yet another object of the present invention is to provide a system and methods that access, compare, and report on the similarities and differences between the conceptual definitions of sphere of fair personal use attached to an electronic manifestation of content, as defined by a content creator, and a similar definition created by the user.

A further object of the present invention provides a system and methods to describe valid electronic content transformations or modulations and rules constraining the triggering of such transformations. These electronic transformation descriptions enrich the electronic content because their existence enables third-party systems to modulate content for specific rendering systems based on target rendering system capabilities while taking into account creator-approved transformation rules.

Another object of the present invention provides a system and methods to programmatically perform approved electronic transformations with or without interaction by another entity, such as a program or human. Through such approved transactions, programmatic engines can control electronic content modulation for the purpose of transferring and eventually rendering the content in alternative rendering systems. The programmatic engine can also enforce the conceptual sphere of fair use, described above, such that these content transformations only take place once the purpose of the transformation has been deemed as falling within the definition of fair use associated with the electronic manifestation of the content.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention extends and enhances existing advances and technologies in the fields of electronic content creation, electronic content usage rights enforcement and electronic content rendering systems by defining systems and methods capable of supporting fair and flexible electronic content usage. The invention provides a clean logical separation between content data objects and ancillary objects related to the content. In a preferred embodiment, such ancillary objects include, but are not limited to, content metadata, content usage rights, and fair use sphere definition and modulation rules.

In a preferred embodiment, the content data object and the different ancillary objects may be either concatenated or inter-twined into a single deliverable electronic object that allows self-contained, network-independent functional scenarios. In an alternative embodiment, the various objects may exist in different distributed network locations, and may be downloaded and accessed on an as-needed basis, thus enabling network-wide ancillary object updates and content data object delivery or updates to take place independently.

By encompassing critical authorization information within the fair use sphere definition and modulation rules object, the invention can also be seen as encouraging the use of techniques similar to traditional PKI tamper detection techniques. By way of example, the present invention can enable a content creator to digitally sign a fair use sphere definition and modulation rules using a private key, thus allowing any content distributor or user to use standard PKI techniques, such as signature verification, to verify the integrity of the object prior to using it in any way. The above reference to PKI techniques should be considered as exemplary and not as limiting on the scope of this invention. Additional encryption mechanisms may also be used to encrypt the defined sphere of fair use and the modulation rules object for added protection.

The present invention provides mechanisms through which content creators can define spheres of fair content use for each electronic content data object. This sphere of fair content use provides parameters delimiting the degree of latitude provided by a content creator for how a user makes practical use of the electronic content. This practical usage definition focuses around rendering systems capable of processing the electronic content either directly or via intermediate transformation for the purposes of providing a rendition of the content data object.

Such definition objects can provide information regarding the classes of rendering systems approved for content rendering based on content rendering system capabilities. For example, rendering systems may be classified based on their features along the following axes: rendering capabilities (text, image, sound, movie), and network connectivity (direct wired, indirect tethered, wireless). For the purposes of describing this aspect of the invention, the preceding rendering system classification axes are meant to be exemplary rather than comprehensive.

Through these definition objects, content creators can define which rendering system classes are considered part of the sphere of fair content use. In addition, a content creator may specify whether or not there is a limit on the number of rendering systems of a specific class allowed to render the electronic content for each user. This definition phase allows a content creator to flexibly differentiate between content usage in high-resolution versus lower resolution rendering systems and to adjust the fair content usage definition accordingly. For example, the definition system allows a content creator to specify that playback of an entire movie which has been distributed in electronic form is to be limited to a single personal theater entertainment system, while the movie's original sound track, including the unaltered dialog and music, may be played on multiple sound-only rendering systems, such as CD players.

Additionally, the invention allows a content creator to define content modulations or transformations allowed for different rendering system classes. This definition gives a content creator creative control over how elements of the electronic content will be rendered by different rendering system classes. For example, if the original content creation includes audio, a content creator may specify that text-only rendering systems should receive a transcript of the audio track for rendering purposes.

By making the sphere of fair content use definition and content modulation rules generally accessible, a user can decide whether a content creator's defined usage terms are agreeable based on provided functionality, pricing, and other personal, technical or financial factors that may affect a particular user's purchase decision process. Once the user has purchased, selected, or otherwise legally obtained a license or other right to the electronic manifestation of the content from a content distributor, the electronic content bundle can be delivered to the user using the distributor's preferred delivery method. Such delivery methods may include, but are not limited to: magnetic tape, CD, optical media, and Internet delivery. It is important to note that in some instances delivery may not imply direct delivery to the user's physical locale, but rather delivery to a network destination serving as the virtual content repository for that user.

After the content user has obtained the electronic content, the present invention provides programmatic capabilities enabling the user to transfer the electronic content to additional rendering systems. Given that different rendering system classes provide different levels of rendering capabilities, the invention compares a specific rendering system's capability description against the electronic content's sphere of fair content usage and content transformation rules. If the rendering system's capabilities limit the original electronic content, the invention provides pluggable templates to perform appropriate, approved transformation that makes content suitable for the new target rendering system. By way of example, without intending to limit the present invention, a request to transfer and render an electronic book consisting of images and text to a rendering system that does not support images could trigger the preparation of the original electronic book to include just the textual portions of the work prior to the transfer to the rendering system. For additional security, the resulting modulated content data object could be encrypted using a scheme that matches the original content data object encryption scheme.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram providing a logical view of electronic content item parts.

FIG. 2 is a block diagram depicting a scenario in which the electronic content and its ancillary objects are integrated into a single electronic object which does not require network connectivity for transformation and rendering of said electronic content.

FIG. 3 is a block diagram illustrating a distributed electronic content scenario in which a content data object and its ancillary objects are distributed across a network, and in which full or temporary network connectivity may be utilized for the purposes of content transformation and rendering.

FIG. 4 is a block diagram illustrating different aspects involved in a sample, initial electronic content preparation and packaging process.

FIG. 5 is a table providing a sample rendering system classification based on rendering capabilities of a target rendering system.

FIG. 6 is a block diagram illustrating details of a sample sphere of fair use definition, including device classes and quantity limitations.

FIG. 7 is a block diagram depicting a sample content modulation rule definition structure.

FIG. 8 is a flow diagram depicting different potential content modulations and control flow for transformation of different components of the textual portions of electronic content.

FIG. 9 is a flow diagram depicting different potential content modulations and control flow for transformation of different components of the image portions of electronic content.

FIG. 10 is a flow diagram depicting different potential content modulations and control flow for transformation of different components of the audio portions of electronic content.

FIG. 11 is a flow diagram depicting different potential content modulations and control flow for transformation of different components of the video portions of electronic content.

FIG. 12 is a block diagram providing a visual description of logical steps and information exchanges associated with a preferred electronic content acquisition process.

FIG. 13 is a Unified Modeling Language (UML) sequence diagram illustrating details of electronic content transfer requests and associated transforms for the purposes of electronic content rendering in alternative rendering systems.

### DETAILED DESCRIPTION OF THE PREFERRED EMBODIMENT

Reference will now be made in detail to the preferred embodiments of the present invention, examples of which are illustrated in the accompanying drawings.

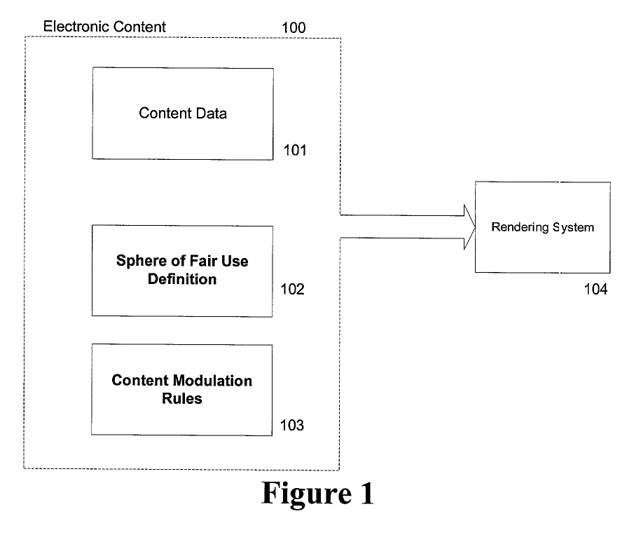

FIG. 1 is a block diagram illustrating logical components associated with a preferred electronic manifestation of content 100. For the purpose of describing the invention, FIG. 1 presents a clear logical separation between the actual electronic representation of content, or content data object 101 and the set of ancillary objects that enable the practical aspects of electronic content usage. This set of ancillary objects includes, but it is not limited to, sphere of fair use definition 102 and content modulation rules 103. Additional or alternative ancillary objects may be defined independently from the objects set forth above for technological or business purposes.

Sphere of fair use object 102 and content modulation rules object 103 represent important facets of the present invention. Sphere of fair use object 102 allows a content creator to define what content rendering practices are considered valid. Such definitions can help address real world issues associated with users owning a variety of rendering systems 104 capable of rendering original content in some manner. Content modulation rules object 103 provides a content creator with a vehicle to define and communicate transformation rules that can be applied by a user to adapt an original content data object 101 for rendering purposes in different rendering systems 104.

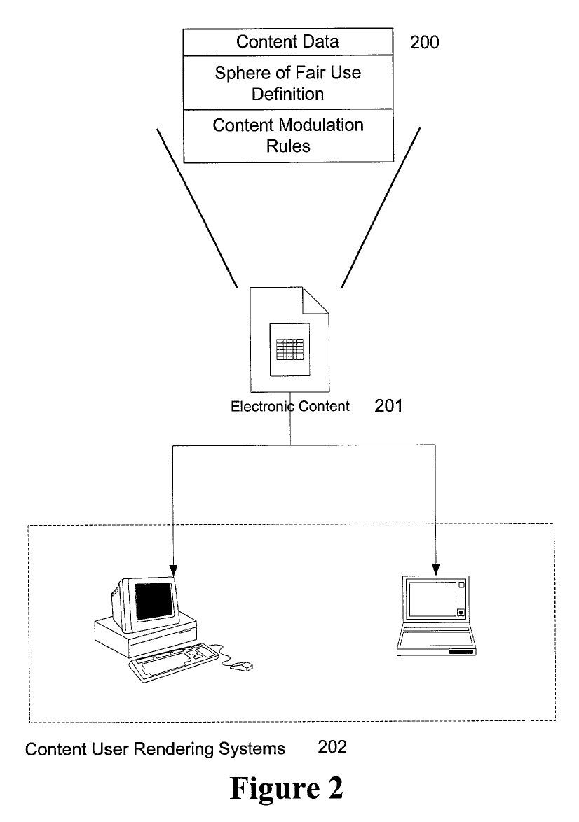

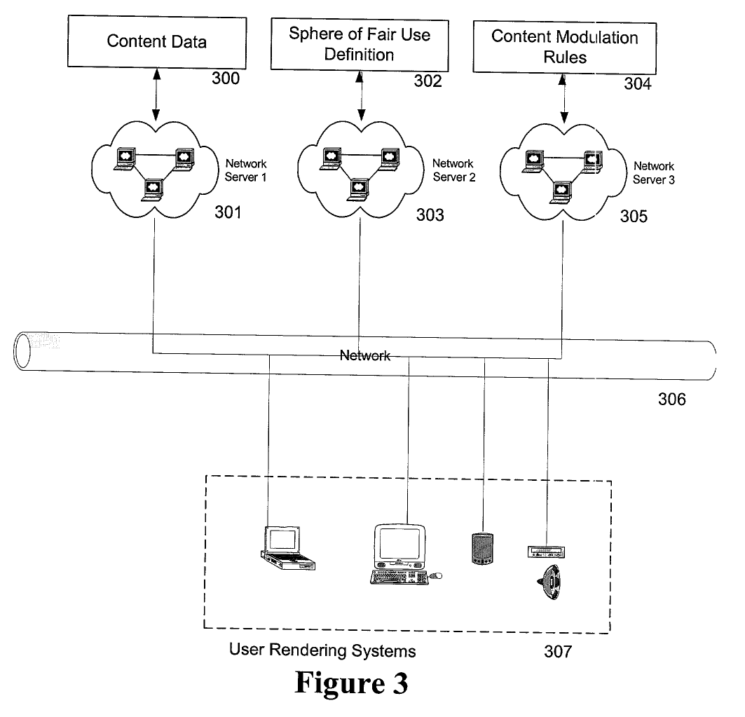

FIGS. 2 and 3 present alternative embodiments of an electronic content object. In FIG. 2, the electronic content object 201 is represented as a single electronic entity that contains the content data object and all of its ancillary objects 200. This single electronic content object entity may be achieved by concatenating or intertwining individual components that make up the full object. Once the all encompassing electronic content object is delivered to a user, the invention does not necessarily require a user to remain connected to a network. Given that the structure of the electronic content object contains information necessary to make content rendering determinations (i.e. the sphere of fair use definition) and content processing decisions (i.e. the modulation rules), one of ordinary skill in the art should be able to implement a networkless system capable of presenting and rendering electronic content 202 Through one or more computer programs, electronic hardware, or a combination of hardware and software.

FIG. 3 presents a distributed electronic content object embodiment, in which content data objects and ancillary objects may be distributed across multiple network server locations 301, 303, 305 which may be connected via a common communications network infrastructure 306. Such an approach can allow construction of ubiquitous content rendering systems 307 that allow users to access and render content from different physical locations. Such content rendering systems 307 may take advantage of traditional caching techniques to only download the different objects as needed or if the network copy is more recent than the locally cached copy.

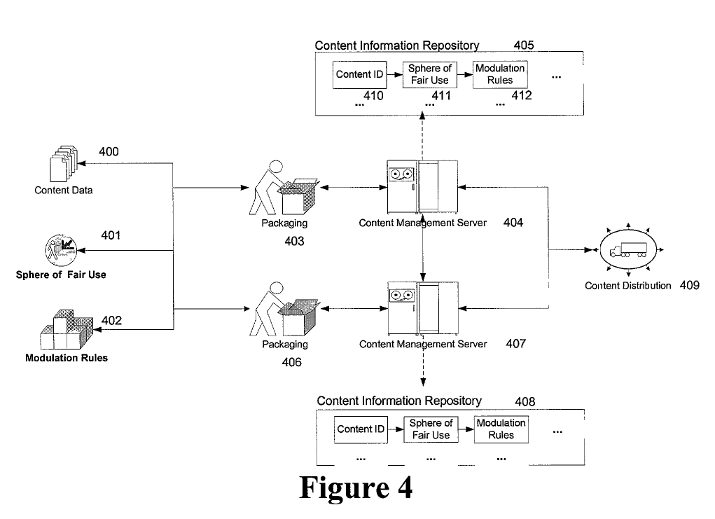

The present invention introduces the concept of an extended content creation and packaging stage that goes beyond traditional content composition tools and mechanics by including activities associated with fair sphere of use definition and content modulation rules preparation. FIG. 4 illustrates concepts involved in distributed content preparation for fair and flexible ubiquitous content usage. The invention introduces the concept of a packaging tool 403/406 that allows the content creator to interact simultaneously with electronic content data object 400 as well as with its ancillary objects. For the purposes of describing the invention, the ancillary objects are limited to sphere of fair use definition 401 and content modulation rules 402. This list of ancillary objects is not meant to be comprehensive, although it is important to note that the sphere of fair use definition 401 and the content modulation rules 402 are central to the present invention.

As illustrated in FIG. 4, the present invention provides an architecture through which multiple distributed instances of packaging tools 403 and 406 can operate. Packaging tools 403 and 406 can generate a unique identifier 410 for each electronic content object created. Unique identifier 410 can be stored in content information repositories 405 and 408 and associated with content management servers 404 and 407. Each unique content identifier 410 contains encoded information that uniquely identifies the network location of content management servers 404 and 407 on which information associated with the packaged content is stored. Content management servers 404 and 407 may store such information in an appropriate content information repository 405/408.

In FIG. 4, packaging tool 403 can be seen as encoding the network location of content management server 404, thus providing an index of content information repository 405. In turn, content information repository 405 can be seen as containing data associated with electronic content objects created by packaging tool 403.

In practical terms, content identifiers 410 can enable a user or application to readily access information associated with a particular electronic content manifestation that may be stored in a content information repository. Given that the present invention centers around fair and flexible electronic content use, a preferred content information repository 405/408 embodiment should contain, but is not limited to containing content identifier (content id) 410, sphere of fair use definition 411, and content modulation rules 412 for each electronic content manifestation created. The present invention also allows the definition of electronic content manifestations consisting of other previously packaged content manifestations in a recursive manner, thus enabling and including the creation of derivative and cumulative works.

During packaging, a content creator can use a packaging tool, such as packaging tool 403, to define a sphere of fair personal use. Spheres of fair personal use can allow a user to make electronic content purchase decisions without regard for rendering systems. This separation allows a user to keep up with rendering system improvements while eliminating the need to purchase a new format of an already purchased electronic content manifestation as new rendering systems are introduced, or additional rendering system functionality becomes available.

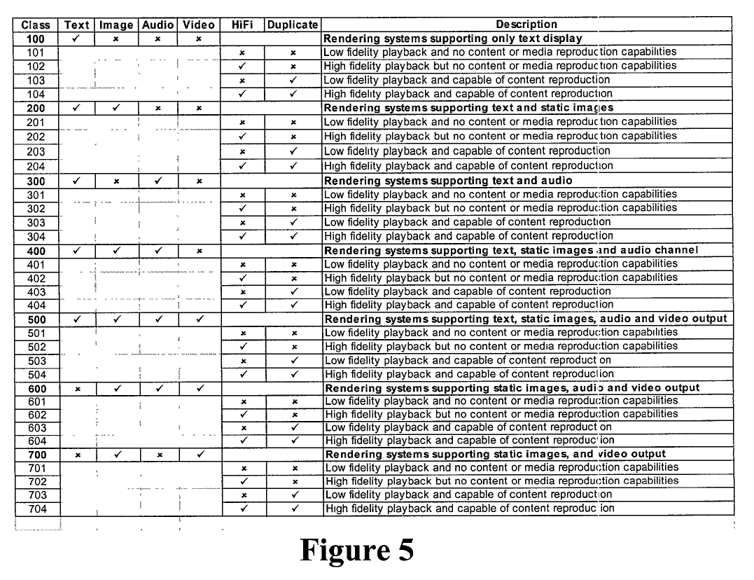

A preliminary step to this phase is the creation of a universally agreeable rendering system classification scheme. FIG. 5 presents a sample rendering s stem classification table which is based on media capabilities and rendering system special considerations. The table shown in FIG. 5 provides a top-level breakdown based on media types supported by the rendering system and includes combinations of text, image, audio, and video playing capabilities.

Within each of the proposed main classes, the presented rendering system classification uses a series of features aimed at describing the quality and “power” of the target rendering system. In FIG. 5, the second level classification focuses on the overall level of fidelity provided by the rendering system represented by the HiFi column and on the ability to reproduce or duplicate electronic content using the target rendering system represented by the Duplicate column. The classifications presented in FIG. 5 are not meant to provide comprehensive coverage, but rather are exemplary of t typical factors to be considered by one of ordinary skill in the art when implementing such a baseline rendering system classification scheme.

As such classification schemes are created, it is important to keep in mind that an object of the present invention is the definition of an agreeable classification that allows content creators to communicate effectively and unambiguously with content distributors, rendering system providers, and users regarding rendering systems without having to resort to all-inclusive lists of specific rendering systems. The existence of this rendering system classification allows for new rendering systems to be created with minimal or no impact to the baseline classification system. The only instances requiring baseline classification updates involve situations in which a new rendering system provides a previously unknown but significant rendering enhancement, such as tactile or olfactory feedback.

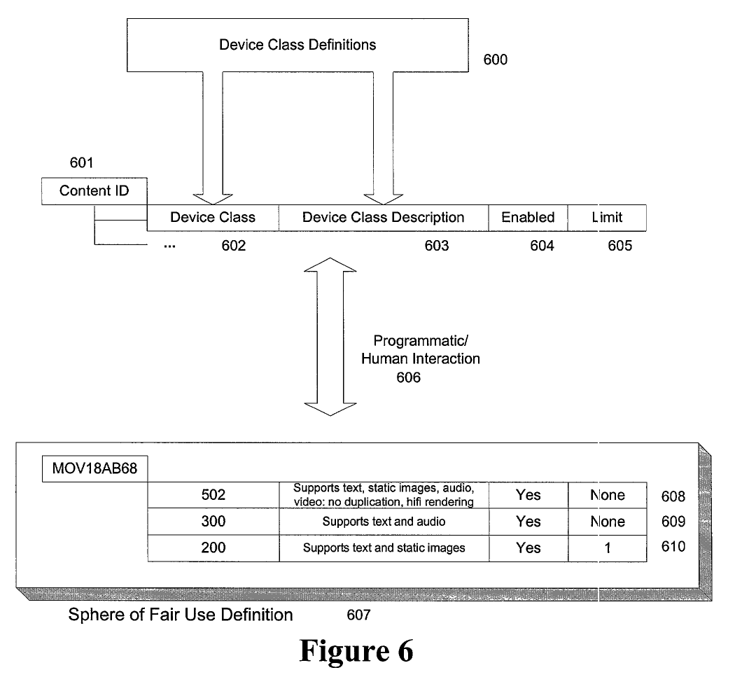

The packaging phase allows a content creator to define the sphere of fair use by creating a definition that may contain one or more rendering system entries for each electronic manifestation of content crated, as illustrated by the block diagram in FIG. 6. At the conceptual level, each content id 601 becomes associated with one or more entries containing information necessary to define rendering system class inclusions and exclusions granted by a content creator. Each entry may contain rendering system class 602, rendering system class description 603, an indication of whether the given rendering system class is enabled or disabled 604, and a field to indicate the upper limit (if any) 605 on the number of rendering systems of the given class allowed to render the content associated with the given content id 601. It should be apparent to one skilled in the art that the number of fields may be increased or decreased, and that additional fields can be substituted for those set forth above, without departing from the spirit or scope of the invention. Within the structure set forth above, both the rendering system class 602 and the rendering system class description 603 fields draw their values from the agreed upon rendering system classification 600 described earlier. The upper limit information 605 is only applicable if the rendering system class is enabled 604.

Both the sphere of fair use definition and its association with a particular content id 601 can be represented via textual or in-memory data structures, database representations or any other means capable of enabling external programmatic or human entities to interact with them. Creation and editing of such spheres of use definitions is enabled by the creation of an interface 606 that allows a content creator to interact with conceptual information either programmatically or interactively via a textual or graphical interface.

The lower half of the block diagram in FIG. 6 illustrates a specific example of a sphere of fair personal use definition 607. The example in FIG. 6 makes use of the rendering system classification introduced in FIG. 5, but this is done to further enable a clear understanding of the present invention and should not be construed as limiting the invention to only the rendering system classifications of FIG. 5. The sample sphere of fair use definition 607 assumes an electronic content manifestation with an already assigned unique content id of MOV18AB68. For the purposes of this description, assume content id MOV18AB68 represents an original movie production consisting of video images with a music soundtrack and accompanying dialog.

The content id features three entries that define and limit the manner in which the content user can utilize the electronic content once purchased. First entry 608 in sphere of fair use definition 607 indicates that rendering systems falling under class 502 are allowed to render this work and a content creator has placed no limits on the number of such rendering systems the user is allowed to use for this purpose. Since rendering systems under class 502 support video, audio, images and text at a high fidelity level but support no duplication activities, a content creator enables as many pure rendering devices as the user wishes to utilize at different times and or locales.

Second entry 609 indicates that rendering systems falling under class 300 are allowed to render the work and a content creator has placed no restrictions on the number of such rendering systems that can be employed by the user. Since devices in class 300 support only text and audio and include all subclasses of the 300 series, the content creator in this example has given the user the flexibility to listen to the sound track and read through the movie script in as many devices, whenever and as many times as needed. It should be noted that this definition actually grants the user the freedom to use rendering systems that support duplication, but grants no specific duplication rights to the user. In other words, the defined sphere of fair use allows the content creator to include the possibility of the content user making additional copies as a manageable risk.

Third entry 610 indicates that rendering systems under class 200 are allowed to render the electronic content via static images or textually through a transcript of the soundtrack or script. In addition, a content creator has placed a limit of one on the number of such rendering systems allowed for each user. In this case, a content. creator may have chosen to limit the number of rendering systems because the some of the 200 series systems are capable of duplication and a content creator wants to limit the potential for unauthorized re-distribution.

During content packaging, a content creator can provide content modulation rules to facilitate transfer and transformation of an electronic content manifestation to appropriate user-owned rendering system(s). By allowing a content creator to specify how the electronic content may be transformed at the packaging stage, a content creator can control how the electronic content manifestation will adapt to different rendering systems given the rendering capabilities and overall functionality of such systems.

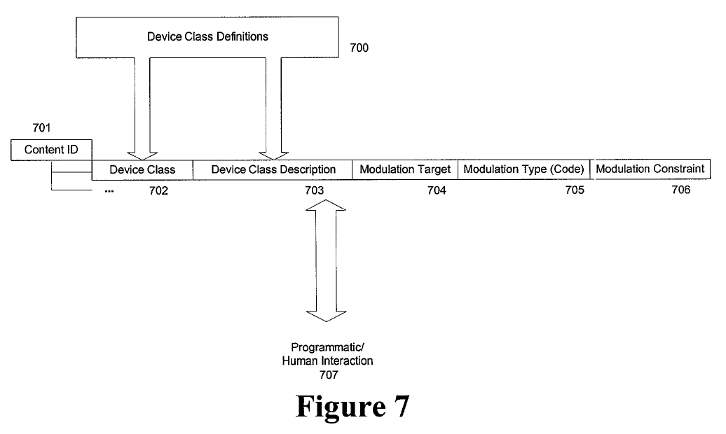

FIG. 7 consists of a block diagram depicting a baseline logical view oi a content modulation rule definition structure. Content modulation rule definitions are associated with an electronic content manifestation via the unique content id. Each electronic content manifestation may have zero or more content modulation rules associated with it. Every content modulation rule definition can consist of a rendering system class id 702 and description 703, which can identify the class of target rendering systems for which the rule applies. Both rendering system class id 702 and description 703 originate from the agreed upon rendering system classification 700 described above in relation to FIG. 5.

The present invention provides a content creator with a means to express content modulation rules that are to be applied at the following baseline levels: individual component (e.g. image modulation for a specific image), file (e.g. text modulation for all text within a file), or the entire content manifestation (e.g. image modulation for all images contained within the complete electronic content manifestation). It should be apparent to one skilled in the art that if a content creator requires additional intermediate logical component groupings within the electronic content manifestation, additional groupings, providing virtually infinite levels, can be implemented without departing from the spirit or scope of the present invention.

The present invention also includes the ability to enforce application of the content modulation rules using a most-specific-first approach. Such an approach allows a content creator to be highly effective during this aspect of the packaging phase because content modulation rules can be provided at the content manifestation level which are to be applied to all the components within the electronic content manifestation, thereby reducing the need for component-level rules to only exceptional cases. By way of example, without intending to limit the present invention, a content creator could specify that all pictures within an electronic content manifestation may be scaled down to a preset thumbnail size, and also specify that certain individual images, such as graphs containing a high density of business critical information, should only be scaled to half their original size. To achieve this level of flexibility, the baseline content modulation rules definition provides a means to store the target component for the modulation rule 704.

The next component of the modulation rule definition is the type of content modulation 705 authorized for designated content component. Modulation type 705 may be accompanied by an optional constraint 706 that is dependent on modulation type 705 itself. Modulation constraint 706 may be used by a content creator to establish limits or ranges to modulation operation results, as defined by the rule in question. For example, an image scaling modulation rule may constrain the result to being no less than 20% of the original image size.

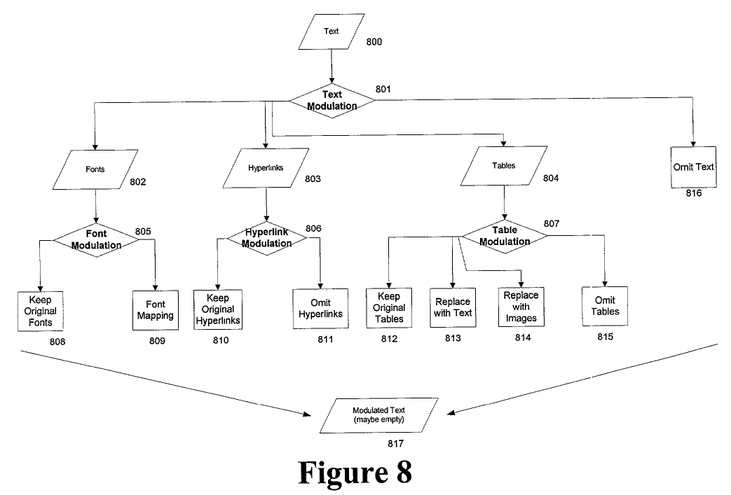

FIGS. 8 through 10 provide flow diagrams depicting baseline modulations that a content creator may use to define the content modulation rules for the text, image, audio and video components of a given electronic content manifestation.

FIG. 8 provides a flow diagram illustrating a level of expressiveness that can be achieved through baseline modulation rules. This is illustrated by using example textual components 800 of an electronic content manifestation. At the top level, a content creator has the option to define text components 800 of an original electronic content manifestation to be eliminated 816 for certain target rendering systems. The remainder of the diagram shows sample text modulation rules grouped into font modulations 805, hyperlink modulations 806, and table modulations 807.

In font modulations 805, a content creator can force the use of the origin al fonts 808 or allow the use of font mapping techniques 809. If a content creator allows font mappings 809, font mapping may be constrained to allow only specific fonts, thereby providing a content creator with very tight control over the look and feel of alternatively rendered content.

Hyperlinks modulations 806 allows a content creator to specify that original links 803 be kept after the transformation 810, or to allow their omission 811. In a preferred embodiment, table modulations 807 gives a content creator the ability to express at least four different rules for table components 804 in the original electronic content. The first option for table components 804 is to require that they be kept as tables 812 in the target rendering system. The second option is to allow the conversion of the original tables 804 into plain text format 813 where a content creator may optionally express a constraint with regards to the result of that conversion being row-major or column-major driven. The third option is to allow the conversion of table components 804 into images 814, thus enabling their display in the target rendering system. The fourth option allows a content creator to allow table components 804 to be omitted 815 from the resulting modulated content 817. The preceding text modulation rules are presented in the description of the invention as being exemplary of the nature of the invention and are not intended to represent comprehensive coverage. One of ordinary skill in the art should be able to provide specific implementations that support supplemental text modulation rules that are consistent with the essence of and within the realm of the invention.

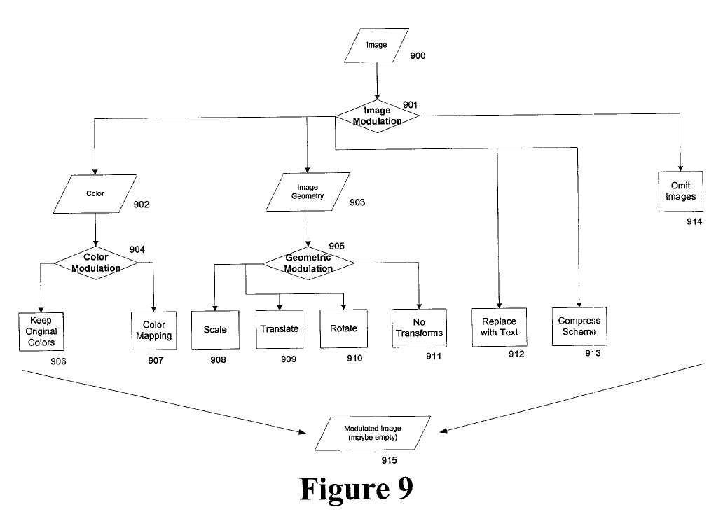

FIG. 9 provides a flow diagram illustrating a level of control achievable through modulation rules, and specifically illustrates the application of modulation rules to image components 900 of an electronic content manifestation. At the top level, a content creator has the option to define certain image components 900 of the original electronic content manifestation to be eliminated 914 for certain target rendering systems. The rest of the diagram shows sample image modulation rules grouped into color modulations 902 and image geometry modulations 903. Color modulations 902 gives a content creator the ability to force the use of the original colors 906 or allow color mapping techniques 907. If a content creator allows color mappings 907, the color mapping constraint may express specific color mappings that are allowed for specific target rendering systems, thereby giving the content creator tighter control over image display.

Inage geometry modulations 903 allows a content creator to express whether any geometric manipulation of the original images 900 is allowed for certain target rendering systems. A content creator may allow scaling 908, translations (moving) 909 and/or rotating 910 of the image components, or transforms 911 may be disallowed.

With all geometric transformations, a content creator may express constraints that limit the extent of such transformations to a target geometry range expressed either as a fixed geometric description or as a percentage of the original geometry. In addition, a content creator may allow the substitution of original image components 900 with text 912 where the constraint may express the specific text to be used to replace the image component(s) in question. Another useful modulation rule allows a content creator to allow alternative image compression techniques 913 for certain image components 900 where the constraint may be used to limit the allowed target image compression formats for the resulting modulated image 915. The image modulation rules presented above are intended to be exemplary of the nature of the present invention, and should not be construed as limiting the present invention to only those techniques.

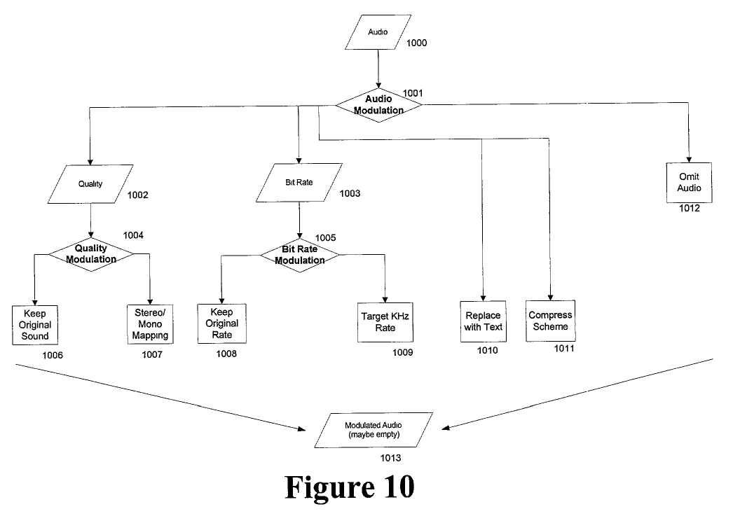

FIG. 10 provides a flow diagram illustrating a level of modulation rule expressiveness that can be accomplished for audio components 1000 of an electronic content manifestation. At the top level, a content creator has the option to define certain audio components 1000 of the original electronic content manifestation to be eliminated 1012 for certain target rendering systems. The rest of the diagram shows sample audio modulation rules grouped into quality modulations 1004 and bit rate modulations 1005. In quality modulations 1004, a content creator can force the use of the original sound quality 1006 or allow the use of modulations to transform the original sound signal into stereo or mono sound 1007. In bit rate modulations 1005, a content creator may express whether any bit rate manipulation of original audio components 1000 is allowed for certain target rendering systems. A content creator may allow bit rate transformations 1009 where the constraint expresses a desired target range (in kilohertz for example) for finer control. Alternatively, a content creator may request that no bit rate transformations 1008 take place. In addition, a content creator may allow the substitution of the original audio components 1000 with the text transcript 1010 of the original audio signal. Another useful modulation rule enables a content creator to allow alternative audio compression techniques 1011 for certain audio components 1000 where the constraint may be used to limit the allowed target audio compression formats for the resulting modulated audio signal 1013. The preceding audio modulation rules are presented in the description of the invention as being exemplary of the nature of the invention and do not represent comprehensive coverage. One of ordinary skill in the art should be able to provide specific implementations that support supplemental audio modulation rules that are consistent with the essence of and within the realm of the invention.

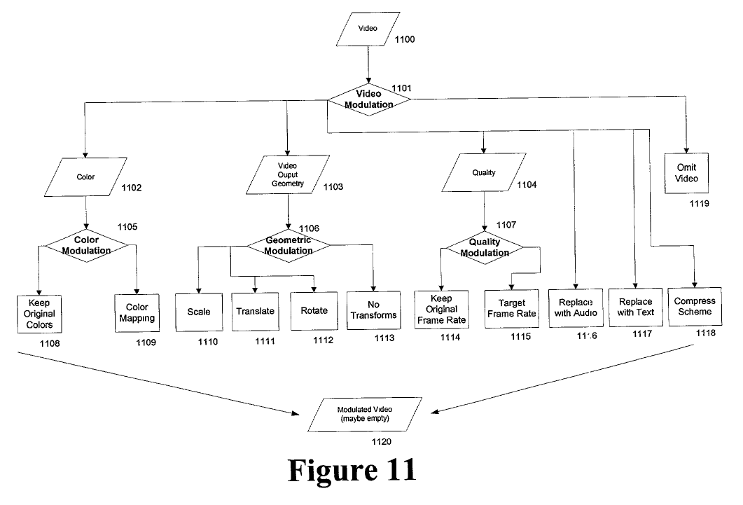

FIG. 11 provides a flow diagram illustrating a level of modulation rule expressiveness that can be accomplished for video components 1100 of an electronic content manifestation. At the top level, a content creator has the option to define certain image components 1100 of an original electronic content manifestation to be eliminated 1119 for certain target rendering systems. The rest of the diagram shows sample video modulation rules grouped into color modulations 1102, video output geometry modulations 1103, and quality modulations 1104.

In color modulations 1102, a content creator can force the use of the original colors 1108 or allow the use of color mapping techniques 1109. If a content creator allows color mappings 1109, the color mapping constraint may express specific color mappings that are allowed for specific target rendering systems for tighter control.

In video output geometry modulations 1103, a content creator may express whether any geometric manipulation of the original video signal 1100 is allowed for certain target rendering systems. A content creator may allow scaling 1110, translations (moving) 1111 and/or rotating 1112 of video output components or transformations may be expressly disallowed 1113. With all geometric transformations, a content creator may express constraints that limit the extent of such transformations to a target geometry range expressed either as a fixed geometric description or as a percentage of the original geometry.

In quality modulations 1104, a content creator may force the maintenance of original frame rate 1114 for certain target rendering systems or frame rate transformation may be allowed 1115 for certain target rendering systems. If frame rate transformations are allowed 1115, the constraint may specify a target frame rate range for tight(r control. In addition, a content creator may allow substitution of original video components 1100 with an audio transcript 1116 of the original electronic content manifestation. A content creator may also allow the substitution of the original video components 1100 with a text transcript 1117 of the original electronic content manifestation. Another useful modulation rule allows a content creator to allow alternative video compression techniques 1118 for certain video components 1100 where the constraint may limit allowed target video compression formats for the resulting modulated video signal 1120. The preceding video modulation rules are presented in the description of the invention as being exemplary of the nature of the invention and do not represent comprehensive coverage. One or ordinary skill in the art should be able to provide specific implementations that support supplemental video modulation rules that are consistent with the essence of and within the realm of the invention.

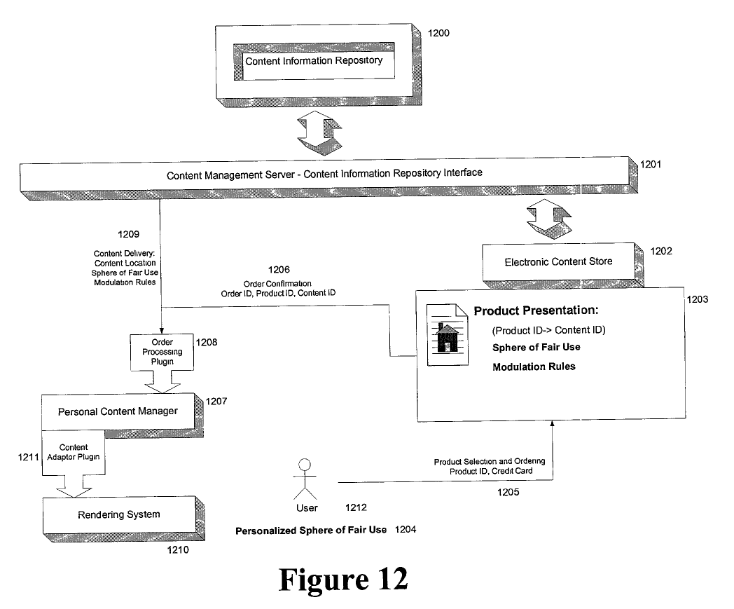

Once the content creator completes the packaging phase, the newly created and configured electronic content manifestation can be made available for purchase, download and rendering as appropriate. FIG. 12 provides a block diagram representation of activities associated with preferred content acquisition and use processes. Once an electronic content manifestation and its ancillary objects are available from an appropriate content information repository 1200, any number of electronic content stores 1202 may present the content to potential users 1212. For the purposes of describing the invention, this document does not delve into the business models that may be supported from said electronic content stores 1202. However, one of the key objects of the invention in this area is the existence of an interface at the content management server 1201 level associated with a particular electronic content manifestation via its content id as explained earlier in this document. Such an interface into the underlying content information repository 1200 enables any of the electronic content stores 1202 to access and display important consumer experience oriented information about the content 1203, such as the sphere of fair use and content modulation rules definitions provided by the content creator during the packaging phase.

The availability of this information within the product presentation 1203 of an electronic content manifestation allows the user 1212 to make informed electronic content purchase decisions based on comparing a user's own definition of sphere of fair use 1204 with the one provided by the content creator. The user 1212 can then make a decision about whether the fair usage constraints and content modulation rules imposed by the content creator will provide the content user with an acceptable rendering experience across the user's rendering systems 1210. At that point, the user 1212 makes a product selection and provides credit card information 1205 or alternate payment means to be used for any charges associated with the transaction.

The electronic content store 1202 can then provide user 1212 with an order confirmation or electronic receipt 1206 that provides the user with information necessary to retrieve the actual electronic content manifestation, including any ancillary objects. Such an order confirmation 1206 typically includes an order id, product id, and content id where the order id and product id are internal to a specific electronic content store 1202, while the content id refers to the unique id associated with the content during the packaging phase.

For the purposes of describing the invention, personal content manager 1207 is best defined as a programmatic entity capable of processing an order confirmation 1206 received from an electronic content store to locate the actual components of the electronic content manifestation, including the content data object, the sphere of fair use definition, and the content modulation rules objects 1209. Because different electronic content stores 1202 may provide slightly different order confirmation formats 1206, personal content manager 1207 can utilize order-processing plug-ins 1208 to interpret and communicate with content stores 1202 using different protocols.

Once personal content manager 1207 has gained access to the content data object and its ancillary objects, user 1212 may request rendering of a particular electronic content manifestation on any one of the available rendering systems. The invention allows for inclusion of pluggable content adaptors 1211 capable of interpreting any applicable content modulation rules included with an electronic content manifestation for specific rendering system classes. Once any necessary transformations have been applied by content adaptor 1210, user 1212 can enjoy the electronic content in the rendering system of his/her choice.

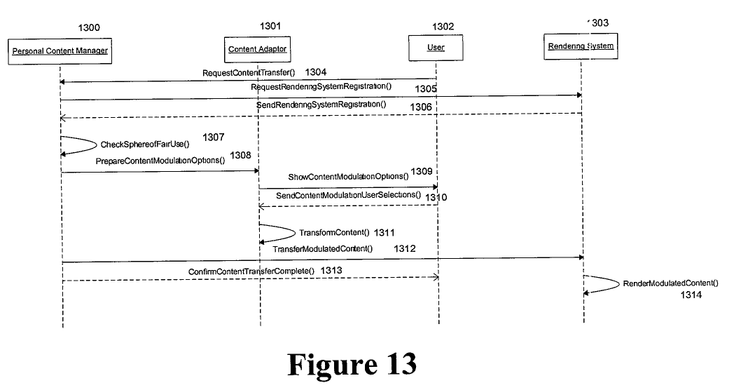

The details of a sample electronic content transfer are presented in the form of a Unified Modeling Language (UML) sequence diagram in FIG. 13. User 1302 initiates the sequence by sending a request to transfer one or more electronic content items to a specific rendering system 1303 via personal content manager 1300. Personal content manager 1300 can be responsible for contacting rendering system of choice 1303 and requesting registration information 1305 corresponding thereto. Registration information provided 1306 by rendering system 1303 can include a description of rendering system 1303 capabilities using an agreed upon rendering system classification such as the system introduced earlier in this document, and identification of the rendering system itself. Rendering system identification may be accomplished through a variety of means, including through a serial number, if the rendering system includes uniquely identifiable hardware components or via a PKI certificate or similar software based secure identification techniques.

Personal content manager 1300 can use rendering system identification information to check 1307 whether the sphere of fair use provided by the content creator at packaging time allows for the transfer to the specified rendering system. If allowed, personal content manager 1300 can locate and notify 1308 an appropriate content adaptor plug-in 1301 to prepare the content for modulation for use by the specified target rendering system 1303. If the content modulation rules allow for alternatives, content adaptor 1301 may present those options 1309 to user 1302 for input.

Once user 1302 makes any necessary selections 1310 from the presented transformation options, the content adaptor performs the content transformation 1311 and transfers the modulated content 1312 to the target rendering system 1303. At this point, the user 1302 has access to the electronic content in the rendering system of his, choice in a manner that matches the rendering system's capabilities while preserving the wishes of the original content creator in terms of flexible content usage and reformatting.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A content packaging system, comprising:
a means of defining one or more spheres of fair use;
a means of defining one or more modulation rules;
a means of associating said one or more spheres of fair use and said one or more modulation rules with said content.

2. The content packaging system of claim 1, further comprising a means of digitally signing said one or more spheres of fair use.

3. The content packaging system of claim 1, further comprising a means of digitally signing said one or more modulation rules.

4. The content packaging system of claim 1, further comprising a means of digitally signing said content.

5. The content packaging system of claim 1, wherein said one or more spheres of fair use are based in part on common rendering device classifications.

6. The content packaging system of claim 1, wherein said one or more modulation rules are based in part on common rendering device classifications.

7. A content packaging method, comprising the steps of:
defining one or more spheres of fair use and content modulation rules for said content; and
storing said one or more spheres of fair use and content modulation rules.

8. The content packaging method of claim 7, in which said content, said one or more spheres of fair use and content modulation rules are distributed across a plurality of servers as part of said storing step.

9. The content packaging method of claim 7, further comprising the step of combining said content, said one or more spheres of fair use and content modulation rules into a single file.

10. The content packaging method of claim 9, further comprising the step of digitally signing said single file.

11. The content packaging method of claim 7, further comprising the step of digitally signing said content and said one or more spheres of fair use and content modulation rules.

12. A flexible content usage method, comprising the steps of:
obtaining content;
obtaining one or more spheres of fair use associated with said content;
obtaining one or more modulation rules associated with said content; and
interpreting and enforcing said one or more spheres of fair use and said one or more modulation rules prior to allowing rendering of said content by a rendering device.

13. A content creation, distribution, and usage system comprising:
a content packaging means, though which one or more spheres of fair use and content modulation rules are associated with said content;
one or more public content management servers;
a content distribution means;
one or more private content management servers; and
a rendering device.

14. The content creation, distribution, and usage system of claim 13, wherein said content distribution means is capable of generating order confirmations, and said one or more private content management servers are capable of interpreting said order confirmations and using information contained therein to provide access to content and content attributes.

15. The content creation, distribution, and usage system of claim 14, in which information contained in said order confirmation includes one or more spheres of fair use associated with said content from said packaging means.

16. The content creation, distribution, and usage system of claim 14, in which information contained in said order confirmation includes one or more modulation rules associated with said content from said packaging means.

17. The content creation, distribution, and usage system of claim 13, wherein said private content management servers are capable of applying said modulation rules associated with said content to said content prior to allowing said rendering, device to render said content.

18. The content creation, distribution, and usage system of claim 13, wherein said private content management servers are capable of applying said spheres of fair use associated with said content to said content prior to allowing said rendering device to render said content.

19. The content creation, distribution, and usage system of claim 13, wherein said rendering system is capable of applying said modulation rules associated with said content to said content prior to rendering said content.

20. The content creation, distribution, and usage system of claim 13, wherein said rendering system is capable of applying said spheres of fair use associated with said content to said content prior to rendering said content.

21. A content creation, distribution, and usage method, comprising the steps of packaging said content;
storing said packaged content and content attributes on one or more content at management servers;
distributing said content and said content attributes to users;
storing said distributed content in one or more private content management servers; and
rendering said content for a user.

22. The content creation, distribution, and usage method of claim 21, in which said content attributes include one or more spheres of use and modulation rules.

23. The content creation, distribution, and usage method of claim 22, in which said step of storing said distributed content in a private content management server also includes storing said content attributes in said one or more private content management servers.

24. The content creation, distribution, and usage method of claim 22, in which said content attributes are accessed by said one or more private content management servers prior to permitting said rendering device to render said content.

25. The content creation, distribution, and usage method of claim 24, further comprising the steps of:
examining said spheres of fair use associated with said content to determine whether said content can be rendered by said rendering device; and
allowing or denying rendering by said rendering device based on said examination.

26. The content creation, distribution, and usage method of claim 24, further comprising the steps of:
examining said modulation rules associated with said content to determine whether said content should be modulated prior to rendering by said rendering device, and
performing any necessary content modulations prior to allowing said content to be rendered by said rendering device.

27. A rendering device classification method, comprising the steps of:
creating a list of commonly used rendering means;
subdividing said rendering means list by adding one or more categories to each rendering means representing abilities of rendering devices within each rendering means;
assigning major classification codes to said commonly used rendering means; and
assigning minor classification codes to said subdivisions.

28. A rendering device classification method, comprising the steps of:
creating a list of the five senses;
adding combinations of said senses to said list;
subdividing each sensory combination listing into media capabilities common to commonly used rendering means appropriate to said sensory combination;
adding one or more categories to each subdivision representing abilities of rendering devices within each rendering means;
assigning major classification codes to said sensory combinations; and
assigning minor classification codes to said categories.

29. A system for defining spheres of fair use, comprising:
a user interface;
a means of selecting content through said user interface;
a means of selecting one or more rendering device classifications through said user interface; and
a means of indicating allowance or denial of content rendering by rendering devices within said selected rendering device classifications, where said allowance or denial is indicated through said user interface.

30. The spheres of fair use definition system of claim 29, further comprising a means of indicating a limit to the number of rendering devices of said one or more rendering device classifications on which said selected content can be rendered.

31. The spheres of fair use definition system of claim 29, further comprising a means of indicating a limit to the number of times said selected content can be rendered.

32. The spheres of fair use definition system of claim 29, further comprising a means of indicating a limit to the number of times said one or more selected rendering device classifications can render said selected content.

33. A modification rule definition method, comprising the steps of:
selecting content through a user interface;
selecting one or more rendering device classifications through said user interface;
selecting one or more components of said content through said user interface;
selecting one or more modulation types appropriate to said one or more selected rendering device classifications, where said selections are made through said user interface; and
indicating whether said one or more modulation types is to be allowed or denied when a rendering device belonging to said one or more selected rendering device classifications attempts to render said one or more selected content components, where said indications are made through said user interface.

34. The modification rule definition method of claim 33, further comprising the step of indicating one or more modulation constraints to be applied when said one or more modulation types is allowed, where said one or more modulation constraints is indicated through said user interface.

35. A system for modification rule definition, comprising:
a user interface;
a means of selecting content through said user interface;
a means of selecting one or more rendering device classifications through said user interface;
a means of selecting one or more components of said content, including the content as a whole, through said user interface;
a means of selecting one or more modulation types appropriate to said one or more selected rendering device classifications through said user interface; and
a means of indicating whether said one or more modulation types is to be allowed or denied when a rendering device belonging to said one or more selected rendering device classifications attempts to render said one or more selected content components, where said indications are made through said user interface.

36. The modulation rule definition system of claim 35, further comprising a means of indicating one or more modulation constraints to be applied when said one or more modulation types is allowed, where said one or more modulation constraints is indicated through said user interface.

37. A modification rule definition means, comprising the steps of:
selecting content through a user interface;
selecting one or more rendering device classifications through said user interface;
selecting one or more components of said content via said user interface;
selecting one or more modulation types appropriate to said one or more selected rendering device classifications from a list of available modulation types presented in said user interface; and
indicating where said one or more selected modulation types is to be allowed or denied when said one or more selected rendering device classifications attempts to render said one or more selected content components, where said indications are made through said user interface.

38. The modification rule definition means of claim 37, further comprising the step of using said user interface to indicate one or more modulation constraints which limit the scope of the modulations when said one or more modulation types is allowed.
